(19) United States
(12) Patent Application Publication
(10) Pub. No.: US 2015/0102921 A1
(43) Pub. Date: Apr. 16, 2015

(54) MICRO LEAKAGE DETECTING DEVICE OF SUSPENSION DEVICE AND METHOD FOR DETECTING MICRO LEAKAGE

(71) Applicant: HYUNDAI MOBIS CO., LTD., Seoul (KR)

(72) Inventor: Young Il KIM, Yongin-si (KR)

(73) Assignee: HYUNDAI MOBIS CO., LTD., Seoul (KR)

(21) Appl. No.: 14/222,427

(22) Filed: Mar. 21, 2014

(30) Foreign Application Priority Data
Oct. 10, 2013 (KR) 10-2013-0120664

(51) Int. Cl. B60Q 9/00

(52) U.S. Cl. CPC B60Q 9/00
USPC 340/450

(57) ABSTRACT

A micro leakage detecting device of a suspension device includes a detecting unit, a driving state determining unit that checks whether or not a vehicle is driving when it is checked in the detecting unit that the vehicle-height correcting control occurs, a vehicle-height increasing control checking unit that checks whether or not the vehicle-height correcting control is control for increasing a vehicle height when it is checked in the driving state determining unit that the vehicle is driving, a micro leakage determining unit that updates vehicle-height correcting control information according to a vehicle-height correcting type when it is checked in the vehicle-height increasing control checking unit that the the vehicle-height correcting control is the control for increasing the vehicle height, and determines whether or not micro leakage occurs when the vehicle-height correcting control information is detected one or more times, and a warning unit that warns a driver.

### CROSS-REFERENCE TO RELATED APPLICATIONS

This application claims priority to and the benefit of Korean Patent Application No. 10-2013-0120664 filed in the Korean Intellectual Property Office on Oct. 10, 2013, the entire contents of which are incorporated herein by reference.

### TECHNICAL FIELD

The present invention relates to a micro leakage detecting device, and more particularly, to a micro leakage detecting device of a suspension device that adjusts a height of a vehicle by using air pressure.

### BACKGROUND ART

A suspension device that has been currently used in a vehicle may have both a vehicle-height control function and a damping function. The vehicle-height control is used to adjust a vehicle height by using hydraulic pressure or air pressure. The vehicle height is decreased to reduce air resistance and improve handling performance during high-speed driving in a general paved road, whereas the vehicle height is increased to improve driving performance in a rough road.

The suspension device includes a vehicle-height adjusting device in order to perform the vehicle-height control. The vehicle-height adjusting device may include a solenoid valve block, an air spring, an air tank, and a compressor.

Here, the solenoid valve block selectively supplies compressed air to the air spring or stops the supply of the compressed air. The air spring receives the compressed air from the solenoid valve block to move a front axle and a rear axle up and down. Four air springs may be respectively provided at a front left side, a front right side, a rear left side, and a rear right side of the vehicle, and the solenoid valve block may include solenoid valves that are respectively connected to the four air springs.

The air tank receives the compressed air from the solenoid valve block and stores the received air, and the compressor serves to suck external air, compress the sucked air, and supply the compressed air.

When there is a difference between a target vehicle height and a current vehicle height, the vehicle-height adjusting device calculates the difference and controls the current vehicle height to become equal to the target vehicle height. For example, when vehicle-height increasing control is performed, if the air tank sufficiently stores air, the control is performed using the stored air. Meanwhile, if the air tank insufficiently stores air, the control is performed using the compressor. When vehicle-height decreasing control is performed, the control may be performed by discharging the external air through an exhaust valve positioned inside the compressor.

The suspension device may be provided with a fail-safe system. When failure occurs, Generally, the fail-safe system priorities according to a degree of influencing the system to appropriately restrict the driving of the corresponding system.

In the vehicle-height adjusting device, the compressed air may leak, and failure caused by the leakage may be detected and respond by the fail-safe system. For example, when abnormal vehicle-height control is performed due to the leakage, when a time to perform the vehicle-height control is excessively taken, or when abnormality occurs in filling the air tank, the failure or abnormality is appropriately detected by the fail-safe system to restrict the corresponding system.

However, such failure corresponds to a case where leakage occurs and components are damaged to such an extent as not to control the suspension device. When a pin hole is formed in the air spring or an air pressure line to cause the micro leakage, since the amount of leakage is not large, the micro leakage may not be detected by the fail-safe system.

Accordingly, when the micro leakage occurs, the vehicle-height correcting and the filling of the air tank are unnecessarily continued, and operating times of the compressor and the solenoid valve block are increased. Thus, the components may be damaged and life spans thereof may be reduced.

### SUMMARY OF THE INVENTION

The present invention has been made in an effort to provide a micro leakage detecting device of a suspension device that detects micro leakage in early stage to prevent components from being damaged and from being reduced their life spans.

An exemplary embodiment of the present invention provides a micro leakage detecting device of a suspension device including: a detecting unit that checks whether or not vehicle-height correcting control occurs; a driving state determining unit that checks whether or not a vehicle is driving when it is checked in the detecting unit that the vehicle-height correcting control occurs; a vehicle-height increasing control checking unit that checks whether or not the vehicle-height correcting control is control for increasing a vehicle height when it is checked in the driving state determining unit that the vehicle is driving; a micro leakage determining unit that updates vehicle-height correcting control information according to a vehicle-height correcting type when it is checked in the vehicle-height increasing control checking unit that the the vehicle-height correcting control is the control for increasing the vehicle height, and determines whether or not micro leakage occurs when the vehicle-height correcting control information is detected, one or more times; and a warning unit that warns a driver when it is determined in the micro leakage determining unit that the micro leakage occurs.

The micro leakage determining unit may initialize the vehicle-height correcting control information when it is checked that the the vehicle-height correcting control is not the control for increasing the vehicle height.

The vehicle-height correcting type may be at least any one of a first type that increases a vehicle height of a front left wheel region, a second type that increases a vehicle height of a front right wheel region, a third type that increases a vehicle height of a rear left wheel region, a fourth type that increases a vehicle height of a rear right wheel region, a fifth type that increases a vehicle height of a region toward front wheels with a longitudinal direction center of the vehicle as its center, a sixth type that increases a vehicle height of a region toward rear wheels with the longitudinal direction center of the vehicle as its center, and a seventh type that increases a vehicle height of a region toward the front wheels or a vehicle height of a region toward the rear wheels with an imaginary diagonal reference line as its center that connects the front left wheel region and the rear right wheel region or the front right wheel region and the rear left wheel region.

Another exemplary embodiment of the present invention provides a method for detecting micro leakage of a suspension device including: a) checking whether or not vehicle-height correcting control occurs; b) checking whether or not a vehicle is driving when it is checked that the vehicle-height correcting control occurs; c) checking whether or not the vehicle-height correcting control is control for increasing a vehicle height when it is checked that the vehicle is driving; d) updating vehicle-height correcting control information according to a vehicle-height correcting type when it is checked that the vehicle-height correcting control is the control for increasing the vehicle height; e) determining whether or not micro leakage occurs when the vehicle-height correcting control information is detected one or more times; and f) warning a driver when it is determined in step e) that the micro leakage occurs.

The method may further include initializing the vehicle-height correcting control information when it is checked in step c) that the vehicle-height correcting control is not the control for increasing the vehicle height.

The vehicle-height correcting type may be at least any one of a first type that increases a vehicle height of a front left wheel region, a second type that increases a vehicle height of a front right wheel region, a third type that increases a vehicle height of a rear left wheel region, a fourth type that increases a vehicle height of a rear right wheel region, a fifth type that increases a vehicle height of a region toward front wheels with a longitudinal direction center of a vehicle as its center, a sixth type that increases a vehicle height of a region toward rear wheels with the longitudinal direction center of the vehicle as its center, and a seventh type that increases a vehicle height of a region toward the front wheels or a vehicle height of a region toward the rear wheels with an imaginary diagonal reference line as its center that connects the front left wheel region and the rear right wheel region or the front right wheel region and the rear left wheel region.

According to exemplary embodiments of the present invention, it is possible to detect micro leakage that is not detected in a general fail-safe system to prevent a suspension device from being damaged and from being reduced its life span by determining micro leakage when the vehicle-height correcting type is repeated for the same vehicle-height correcting control more than a reference number.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a micro leakage detecting device of a suspension device according to an exemplary embodiment of the present invention.

FIGS. 2 and 3 are diagrams illustrating vehicle-height correcting control regions.

FIG. 4 is a flowchart illustrating a method for detecting micro leakage of a suspension device according to another exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter, exemplary embodiments of the present invention will be described in detail with reference to the accompanying drawings. It should be noted that throughout the accompanying drawings, the same components are assigned the same reference numerals even in different drawings. The exemplary embodiments of the present invention will now be described, but the technical sprit of the present invention is not limited or restricted thereto. Therefore, it should be appreciated that those skilled in the art can variously change and modify these embodiments.

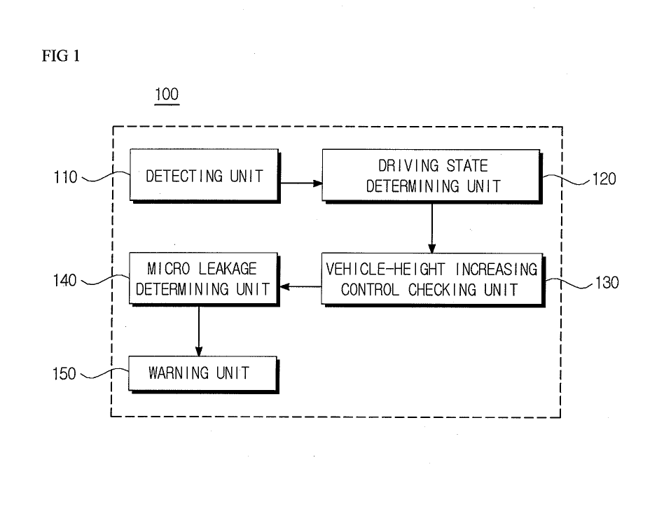

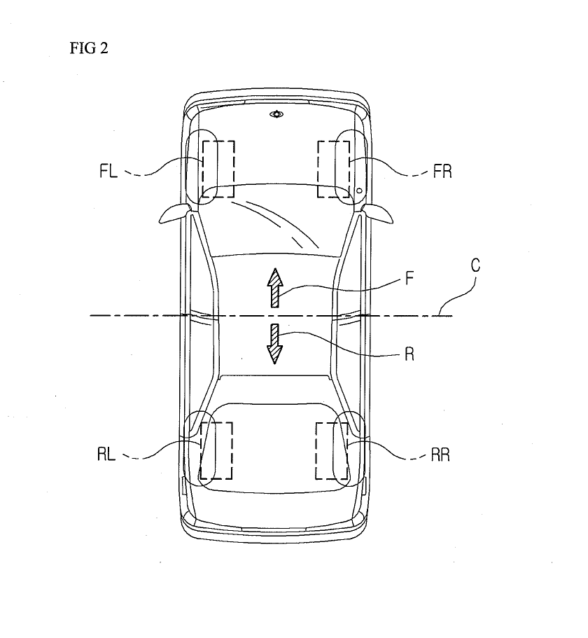

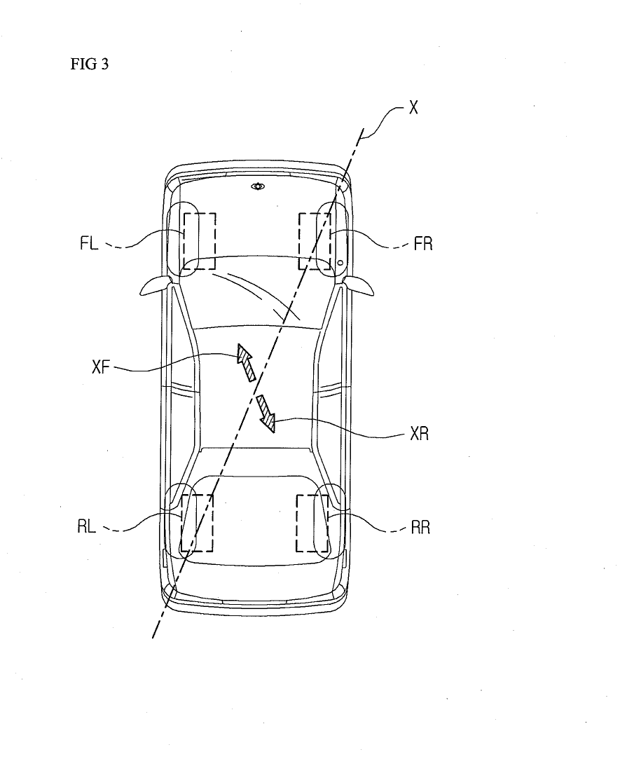

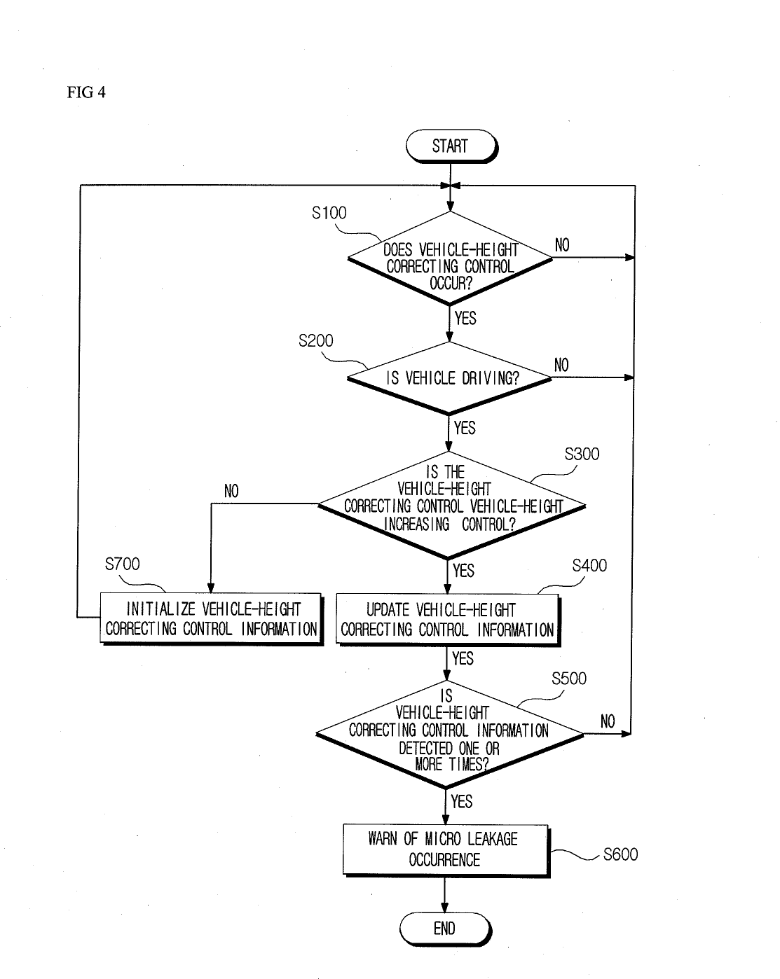

FIG. 1 is a diagram illustrating a micro leakage detecting device of a suspension device according to an exemplary embodiment of the present invention, FIGS. 2 and 3 are diagrams illustrating vehicle-height correcting control regions, and FIG. 4 is a flowchart illustrating a method for detecting micro leakage of a suspension device according to another exemplary embodiment of the present invention.

Referring to FIGS. 1 to 3, a micro leakage detecting device 100 of a suspension device according to the exemplary embodiment of the present invention may include a detecting unit 110, a driving state determining unit 120, a vehicle-height increasing control checking unit 130, a micro leakage determining unit 140, and a warning unit 150.

Referring to FIG. 4, a method for detecting micro leakage by using the micro leakage detecting device 100 of a suspension device according to the exemplary embodiment of the present invention is as follows.

First, the detecting unit 110 checks whether or not vehicle-height correcting control occurs (S100).

Subsequently, when it is checked in the detecting unit 110 that the vehicle-height correcting control occurs, the driving state determining unit 120 determines whether or not a vehicle is driving (S200).

While the vehicle stops, when a passenger gets in or gets off or when freight is loaded to or unloaded, since a weight of the vehicle is changed, the vehicle-height correcting control may occur. For this reason, in the present invention, it is checked whether or not the vehicle is driving to detect whether or not the vehicle-height correcting control occurs due to micro leakage only during the driving.

Thereafter, when it is checked in the driving state determining unit 120 that the vehicle is currently driving, the vehicle-height increasing control checking unit 130 checks whether or not a performed vehicle-height correcting control is control for increasing a vehicle height (S300).

The reason why it is checked whether or not the vehicle-height correcting control is the control for increasing the vehicle height is because when the micro leakage occurs, since the vehicle height is continuously decreased, the vehicle-height correcting control is performed to increase the vehicle height.

Subsequently, when it is checked in the vehicle-height increasing control checking unit 130 that the vehicle-height increasing control is performed, the micro leakage determining unit 140 updates vehicle-height correcting control information according to a vehicle-height correcting type (S400).

The vehicle-height correcting type is classified according to a region of the vehicle height in which the vehicle height is increased. Referring to FIG. 2, the vehicle-height correcting type may be classified into four types, for example, a first type that increases a vehicle height of a front left wheel region FL, a second type that increases a vehicle height of a front right wheel region FR, a third type that increases a vehicle height of a rear left wheel region RL, and a fourth type that increases a vehicle height of a rear right wheel region RR, or may be classified into combinations thereof.

The vehicle-height correcting type may be classified into a fifth type that increases a vehicle height of a region F toward front wheels with a longitudinal direction center C of the vehicle as its center, and a sixth type that increases a vehicle height of a region R toward rear wheels with the longitudinal direction center of the vehicle as its center.

Referring to FIG. 3, the vehicle-height correcting type may include a seventh type that increases a vehicle height of a region XF toward the front wheels or a vehicle height of a region XR toward the rear wheels with an imaginary diagonal reference line X as its center that connects the front right wheel region FR and the rear left wheel region RL. Although not illustrated, the vehicle-height correcting type may include a seventh type that increases a vehicle height of a region toward the front wheels or a vehicle height of a region toward the rear wheels with an imaginary diagonal reference line as its center that connects the front left wheel region FL and the rear right wheel region RR.

The vehicle-height correcting control information means control information that operates a solenoid valve block, a compressor, and an air tank in order to increase the vehicle height according to the first type to the seventh type.

When the vehicle-height correcting control information is checked, the micro leakage determining unit 140 classifies the vehicle-height correcting control information according to the vehicle-height correcting type and updates the vehicle-height correcting control information.

Thereafter, the micro leakage determining unit 140 checks a history of the vehicle-height correcting control information and determines that the micro leakage occurs when the vehicle-height correcting control information is detected one or more times.

When it is determined that the micro leakage occurs, the warning unit 150 provides information to a driver so as to allow the driver to inspect the vehicle. At this time, a warning type of the warning unit 150 may include on or off of a warning lamp of a cluster, an occurrence of a warning sound, and a fault signal input within a CAN signal.

Meanwhile, when the micro leakage occurs, since normal vehicle-height control can be performed, the vehicle-height control is not artificially limited.

On the other hand, when it is checked in the vehicle-height increasing control checking unit 130 that the vehicle-height increasing control does not occur, the micro leakage determining unit 140 initializes the vehicle-height correcting control information (S700).

As described above, the exemplary embodiments have been described and illustrated in the drawings and the specification. The exemplary embodiments were chosen and described in order to explain certain principles of the invention and their practical application, to thereby enable others skilled in the art to make and utilize various exemplary embodiments of the present invention, as well as various alternatives and modifications thereof. As is evident from the foregoing description, certain aspects of the present invention are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

What is claimed is:

1. A micro leakage detecting device of a suspension device, comprising:
a detecting unit that checks whether or not vehicle-height correcting control occurs;
a driving state determining unit that checks whether or not a vehicle is driving when it is checked in the detecting unit that the vehicle-height correcting control occurs;
a vehicle-height increasing control checking unit that checks whether or not the vehicle-height correcting control is control for increasing a vehicle height when it is checked in the driving state determining unit that the vehicle is driving;
a micro leakage determining unit that updates vehicle-height correcting control information according to a vehicle-height correcting type when it is checked in the vehicle-height increasing control checking unit that the the vehicle-height correcting control is the control for increasing the vehicle height, and determines whether or not micro leakage occurs when the vehicle-height correcting control information is detected one or more times; and
a warning unit that warns a driver when it is determined in the micro leakage determining unit that the micro leakage occurs.

2. The micro leakage detecting device of a suspension device of claim 1, wherein the micro leakage determining unit initializes the vehicle-height correcting control information when it is checked that the the vehicle-height correcting control is not the control for increasing the vehicle height.

3. The micro leakage detecting device of a suspension device of claim 1, wherein the vehicle-height correcting type is at least any one of a first type that increases a vehicle height of a front left wheel region, a second type that increases a vehicle height of a front right wheel region, a third type that increases a vehicle height of a rear left wheel region, a fourth type that increases a vehicle height of a rear right wheel region, a fifth type that increases a vehicle height of a region toward front wheels with a longitudinal direction center of the vehicle as its center, a sixth type that increases a vehicle height of a region toward rear wheels with the longitudinal direction center of the vehicle as its center, and a seventh type that increases a vehicle height of a region toward the front wheels or a vehicle height of a region toward the rear wheels with an imaginary diagonal reference line as its center that connects the front left wheel region and the rear right wheel region or the front right wheel region and the rear left wheel region.

4. A method for detecting micro leakage of a suspension device, the method comprising:
a) checking whether or not vehicle-height correcting control occurs;
b) checking whether or not a vehicle is driving when it is checked that the vehicle-height correcting control occurs;
c) checking whether or not the vehicle-height correcting control is control for increasing a vehicle height when it is checked that the vehicle is driving;
d) updating vehicle-height correcting control information according to a vehicle-height correcting type when it is checked that the vehicle-height correcting control is the control for increasing the vehicle height;
e) determining whether or not micro leakage occurs when the vehicle-height correcting control information is detected one or more times; and
f) warning a driver when it is determined in step e) that the micro leakage occurs.

5. The method for detecting micro leakage of a suspension device of claim 4, further comprising:
initializing the vehicle-height correcting control information when it is checked in step c) that the vehicle-height correcting control is not the control for increasing the vehicle height.

6. The method for detecting micro leakage of a suspension device of claim 4, wherein the vehicle-height correcting type is at least any one of a first type that increases a vehicle height of a front left wheel region, a second type that increases a vehicle height of a front right wheel region, a third type that increases a vehicle height of a rear left wheel region, a fourth type that increases a vehicle height of a rear right wheel region, a fifth type that increases a vehicle height of a region toward front wheels with a longitudinal direction center of a vehicle as its center, a sixth type that increases a vehicle height of a region toward rear wheels with the longitudinal direction center of the vehicle as its center, and a seventh type that increases a vehicle height of a region toward the front wheels or a vehicle height of a region toward the rear wheels with an imaginary diagonal reference line as its center that connects the front left wheel region and the rear right wheel region or the front right wheel region and the rear left wheel region.
